(19) United States
(12) Patent Application Publication
(10) Pub. No.: US 2014/0125944 A1
(43) Pub. Date: May 8, 2014

(54) HYBRID CONTACT LENS, METHOD OF PRODUCING THE SAME, AND MOLD SET FOR PRODUCING THE SAME

(71) Applicant: LARGAN PRECISION CO., LTD., Taichung (TW)

(72) Inventor: Chen-Yi Huang, Taichung (TW)

(73) Assignee: LARGAN PRECISION CO., LTD., Taichung (TW)

(21) Appl. No.: 13/864,514

(22) Filed: Apr. 17, 2013

(30) Foreign Application Priority Data
Nov. 2, 2012 (TW) 101140694

(51) Int. Cl. G02C 7/04; B29C 39/10; G02B 1/04; B29D 11/00

(52) U.S. Cl. CPC G02C 7/049; B29D 11/00048; B29C 39/10; G02B 1/043
USPC 351/159.33; 264/1.7; 249/96

(57) ABSTRACT

This invention provides a mold set for manufacturing a hybrid contact lens. The mold set comprises two types of upper molds and a lower mold; alternatively, the mold set comprises an upper mold and two types of lower molds. It is selectable to form the near-center region of a hybrid contact lens first and form the near-periphery region subsequently, or to form the near-periphery region first and the near-center region subsequently. This invention also provides a hybrid contact lens manufactured with any of said mold sets, comprising a first portion and a second portion which are disposed concentrically relative to a center of the hybrid contact lens and adhered to each other. The first portion and second portion are modeled to form a near-center region and a near-periphery region of the hybrid contact lens respectively, wherein the first portion has vision correction properties.

### CROSS-REFERENCE TO RELATED APPLICATION

This non-provisional application claims priority under 35 U.S.C. §119(a) on Patent Application No. 101140694 filed in Taiwan (R.O.C.) on Nov. 2, 2012, the entire contents of which are hereby incorporated by reference.

### BACKGROUND

1. Technical Field

The present invention relates to a hybrid contact lens, its mold set, and manufacturing method; more particularly, the invention relates to a hybrid contact lens manufactured through a hybrid cast molding method using a mold set.

2. Description of the Related Art

Conventional contact lenses may be divided into two types, a rigid type and a soft type. Generally, a polymer material having a relatively lower degree of hydration is utilized to manufacture a rigid contact lens by a conventional processing method; for example, the polymer material is formed into a cylinder through polymerization and then turned into a specific shape according to the design. However, the processing methods and the material properties of rigid contact lenses may often cause discomfort when worn.

On the other hand, a polymer material having a relatively higher degree of hydration is generally utilized to manufacture a soft contact lens; the manufacturing methods include the aforementioned process, a spin casting method disclosed in U.S. Pat. No. 3,408,429, U.S. Pat. No. 3,496,254, and U.S. Pat. No. 3,660,545, and a cast molding method disclosed in U.S. Pat. No. 3,660,545. Specifically, materials which can be utilized to manufacture a soft contact lens include a polymer grid material containing volumes of HEMA (2-hydroxyethyl methacrylate), a monomer acrylate material containing vinyl pyrrolidone as disclosed in U.S. Pat. No. 3,639,524 and U.S. Pat. No. 3,621,079, and a copolymerized compound of acrylamide and acrylate, or and methyl acrylate. Lenses made from these materials are generally softer and jelly-like, which may contain 20 to 90 percentage of water. The more water a lens contains, the softer it is; softer lenses provide more comfort when worn and are more acceptable to consumers. However, a lens with higher water content is accompanied by a decreased tenacity, and thus the lens may be easily broken when applied a force. Furthermore, due to low oxygen permeability of these lenses, long-term wear of soft contact lenses may easily result in health problems, such as corneal hypoxia and corneal inflammation.

To solve the problems relating to low oxygen permeability of materials as mentioned above, U.S. Pat. No. 4,954,587, U.S. Pat. No. 5,010,141, U.S. Pat. No. 5,079,319, U.S. Pat. No. 5,115,056, U.S. Pat. No. 5,260,000, U.S. Pat. No. 5,336,797, and U.S. Pat. No. 5,358,995 disclose utilizing another kind of polymer material, which contains silicone with higher oxygen permeability. However, the edge of a lens made from such material may cause discomfort when worn.

Therefore, to improve the oxygen permeability and comfort level when worn, U.S. Pat. No. 7,150,529 discloses a hybrid contact lens; a center region of the lens is made of a rigid material to improve oxygen permeability, and a peripheral region of the lens is made of a soft material for improved comfort. However, the manufacture of such lenses involves a complicated, time-consuming turning process, which is unfavorable for mass production.

A hybrid contact lens disclosed in U.S. Pat. No. 4,166,255 is manufactured by diffusing a solid material into a soft material; however, shapes of center region and peripheral region of the lens cannot be controlled precisely through this manufacturing method. Another manufacturing method mentioned in the same document is to position a soft material and a preformed rigid lens into a mold in turn, and then continue with a spin casting process; however, this method cannot produce lenses with a more complex design and thus limits the optical performance of lenses. Moreover, this method still relies on a turning or cast molding process to form the preformed rigid lens precisely; the manufacturing process is complicated and time-consuming as well.

### SUMMARY

The present invention provides a mold set for manufacturing a hybrid contact lens. The mold set comprises a first upper mold, a second upper mold, and a lower mold, wherein a lower surface of the first upper mold comprises a convex first upper forming surface and a protruding flange which is disposed at a near-periphery region of the lower surface; a lower surface of the second upper mold comprises a convex second upper forming surface; and an upper surface of the lower mold comprises a concave lower forming surface. The mold set is made of plastic or glass.

On the other hand, the present invention provides a hybrid cast molding method employing said mold set for manufacturing a hybrid contact lens, comprising the following steps: positioning an unpolymerized first material on the lower forming surface of the lower mold; assembling the first upper forming surface of the first upper mold and the lower forming surface of the lower mold; polymerizing and modeling the first material to form a near-center region of a hybrid contact lens as a first portion of the lens; positioning an unpolymerized second material on the lower forming surface of the lower mold; assembling the second upper forming surface of the second upper mold and the lower forming surface of the lower mold; polymerizing and modeling the second material to form a near-periphery region of the hybrid contact lens as a second portion of the lens, wherein the second portion and the first portion are adhered to each other; and hydrating the hybrid contact lens.

The present invention further provides a mold set for manufacturing a hybrid contact lens. The mold set comprises an upper mold, a first lower mold, and a second lower mold, wherein a lower surface of the upper mold comprises a convex upper forming surface; an upper surface of the first lower mold comprises a concave first lower forming surface and a protruding flange which is disposed at a near-periphery region of the upper surface; and an upper surface of the second lower mold comprises a concave second lower forming surface. The mold set is made of plastic or glass.

On the other hand, the present invention provides a hybrid cast molding method employing said mold set for manufacturing a hybrid contact lens, comprising the following steps: positioning an unpolymerized first material on the first lower forming surface of the first lower mold; assembling the upper forming surface of the upper mold and the first lower forming surface of the first lower mold; polymerizing and modeling the first material to form a near-center region of a hybrid contact lens as a first portion of the lens; positioning an unpolymerized second material on the second lower forming surface of the second lower mold; assembling the upper forming surface of the upper mold and the second lower forming surface of the second lower mold; polymerizing and modeling the second material to form a near-periphery region of the hybrid contact lens to as a second portion of the lens, wherein the second portion and the first portion are adhered to each other; and hydrating the hybrid contact lens.

The present invention provides still another mold set for manufacturing a hybrid contact lens. The mold set comprises a first upper mold, a second upper mold, and a lower mold, wherein a lower surface of the first upper mold comprises a convex first upper forming surface and a protruding flange which is disposed at a near-center region of the lower surface; a lower surface of the second upper mold comprises a convex second upper forming surface; and an upper surface of the lower mold comprises a concave lower forming surface. The mold set is made of plastic or glass.

On the other hand, the present invention provides a hybrid cast molding method employing said mold set for manufacturing a hybrid contact lens, comprising the following steps: positioning an unpolymerized second material on the lower forming surface of the lower mold; assembling the first upper forming surface of the first upper mold and the lower forming surface of the lower mold; polymerizing and modeling the second material to form a near-periphery region of a hybrid contact lens as a second portion of the lens; positioning an unpolymerized first material on the lower forming surface of the lower mold; assembling the second upper forming surface of the second upper mold and the lower forming surface of the lower mold; polymerizing and modeling the first material to form a near-center region of the hybrid contact lens as a first portion of the lens, wherein the first portion and the second portion are adhered to each other; and hydrating the hybrid contact lens.

The present invention provides yet another mold set for manufacturing a hybrid contact lens. The mold set comprises an upper mold, a first lower mold, and a second lower mold, wherein a lower surface of the upper mold comprises a convex upper forming surface; an upper surface of the first lower mold comprises a concave first lower forming surface and a protruding flange which is disposed at a near-center region of the upper surface; and an upper surface of the second lower mold comprises a concave second lower forming surface. The mold set is made of plastic or glass.

On the other hand, the present invention provides a hybrid cast molding method employing said mold set for manufacturing a hybrid contact lens, comprising the following steps: positioning an unpolymerized second material on the first lower forming surface of the first lower mold; assembling the upper forming surface of the upper mold and the first lower forming surface of the first lower mold; polymerizing and modeling the second material to form a near-periphery region of a hybrid contact lens to as a second portion of the lens; positioning an unpolymerized first material on the second lower forming surface of the second lower mold; assembling the upper forming surface of the upper mold and the second lower forming surface of the second lower mold; polymerizing and modeling the first material to form a near-center region of the hybrid contact lens as a first portion of the lens, wherein the first portion and the second portion are adhered to each other; and hydrating the hybrid contact lens.

Besides, the present invention provides a hybrid contact lens manufactured by using one of said mold sets as mentioned above, comprising a first portion and a second portion adhered to each other and being concentrically disposed relative to a center of the hybrid contact lens. The first portion and the second portion form a near-center region and a near-periphery region of the hybrid contact lens respectively, wherein the first portion has vision correction properties; the first and second portions are made from different hydratable polymer materials; and the second portion is made from a material containing HEMA (2-hydroxyethyl methacrylate).

### BRIEF DESCRIPTION OF THE DRAWINGS

FIG. 1 is a sectional view of a mold set employed in the first embodiment of the present invention.

FIGS. 1A to 1F are state diagrams of the molds in relative steps of a manufacturing method in accordance with the first embodiment of the present invention.

FIG. 2 is a sectional view of a mold set employed in the second embodiment of the present invention.

FIGS. 2A to 2F are state diagrams of the molds in relative steps of a manufacturing method in accordance with the second embodiment of the present invention.

FIG. 3 is a sectional view of a mold set employed in the third embodiment of the present invention.

FIGS. 3A to 3F are state diagrams of the molds in relative steps of a manufacturing method in accordance with the third embodiment of the present invention.

FIG. 4 is a sectional view of a mold set employed in the fourth embodiment of the present invention.

FIGS. 4A to 4F are state diagrams of the molds in relative steps of a manufacturing method in accordance with the fourth embodiment of the present invention.

FIG. 5A is a perspective view of a prior art hybrid contact lens.

FIG. 5B is a sectional view of the prior art hybrid contact lens in FIG. 5A.

FIG. 6A is a sectional view of a hybrid contact lens in accordance with the first example of the present invention.

FIGS. 6B to 6D illustrate alternative examples of the hybrid contact lens in FIG. 6A.

FIG. 7 is a sectional view of a hybrid contact lens in accordance with the second example of the present invention.

FIG. 8 is a sectional view of a hybrid contact lens in accordance with the third example of the present invention.

FIG. 9 is a sectional view of a hybrid contact lens in accordance with the fourth example of the present invention.

### DETAILED DESCRIPTION OF THE PREFERRED EMBODIMENTS

In this specification, the terms “first upper mold”, “second upper mold”, “first lower mold”, and “second lower mold” as well as “first upper forming surface”, “second upper forming surface”, “first lower forming surface”, and “second lower forming surface” used herein describe the relative sequence when these molds and surfaces are employed during the process of manufacturing a hybrid contact lens of the present invention, and they are not limited to forming either the “first portion” or the “second portion”. However, in this specification, the term “first material” refers to a material used to form a “first portion”, and the term “second material” refers to a material used to form a “second portion”. Besides, the description “disk-like shape” or “ring-like shape” in this specification refers to the shape viewed from the top or bottom of the cornea side of a lens.

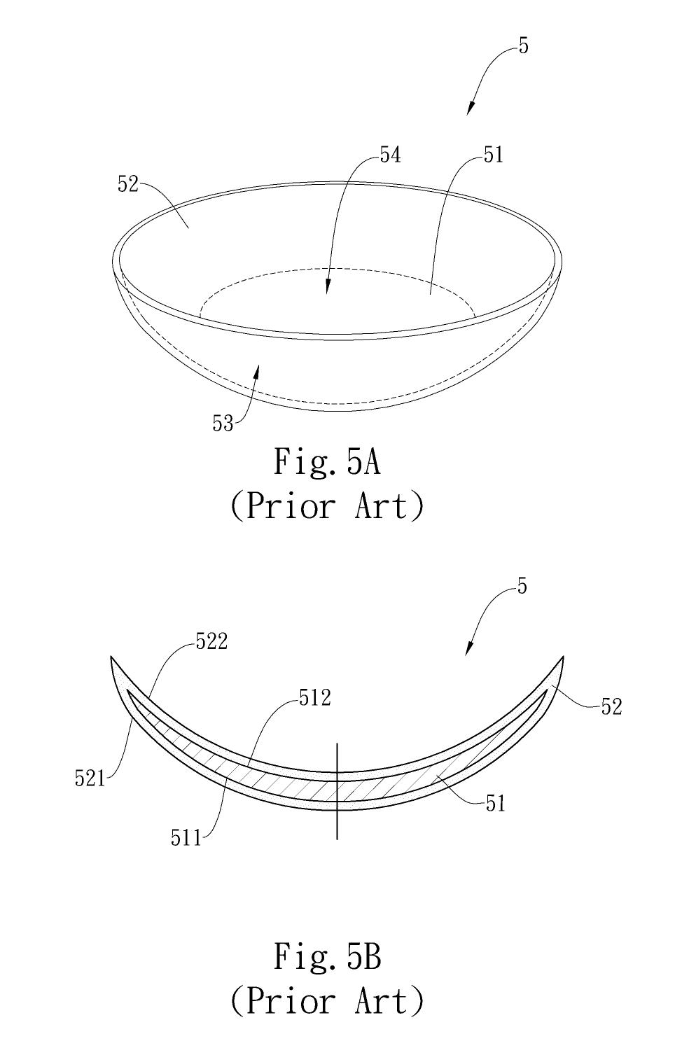

Generally, as shown in FIG. 5A, a hybrid contact lens 5 comprises a first portion 51 and a second portion 52 which are adhered to each other and concentrically disposed relative to a center of the hybrid contact lens 5. The first portion 51 and the second portion 52 form a near-center region and a near-periphery region of the lens respectively, wherein the first portion 51 has vision correction properties, and the second portion 52 makes the hybrid contact lens 5 comfortably fit the surface of the eyeball. The hybrid contact lens 5 comprises a near-object surface 53 and a near-cornea surface 54. FIG. 5B shows a sectional view of the hybrid contact lens 5, wherein the first portion 51 comprises a near-object surface 511 and a near-cornea surface 512, and the second portion 52 comprises a near-object surface 521 and a near-cornea surface 522. To improve the efficiency of manufacturing a hybrid contact lens like the contact lens 5, to alleviate wearers' discomfort caused by the properties of the lens surface after a turning process, and to manufacture a hybrid contact lens with respect to various designs and requirements, the present invention provides a hybrid cast molding method for manufacturing a hybrid contact lens and its mold set. The embodiments of the present invention will be described in the following paragraphs by referring to the accompanying drawings so as to elucidate the present invention.

### The First Embodiment

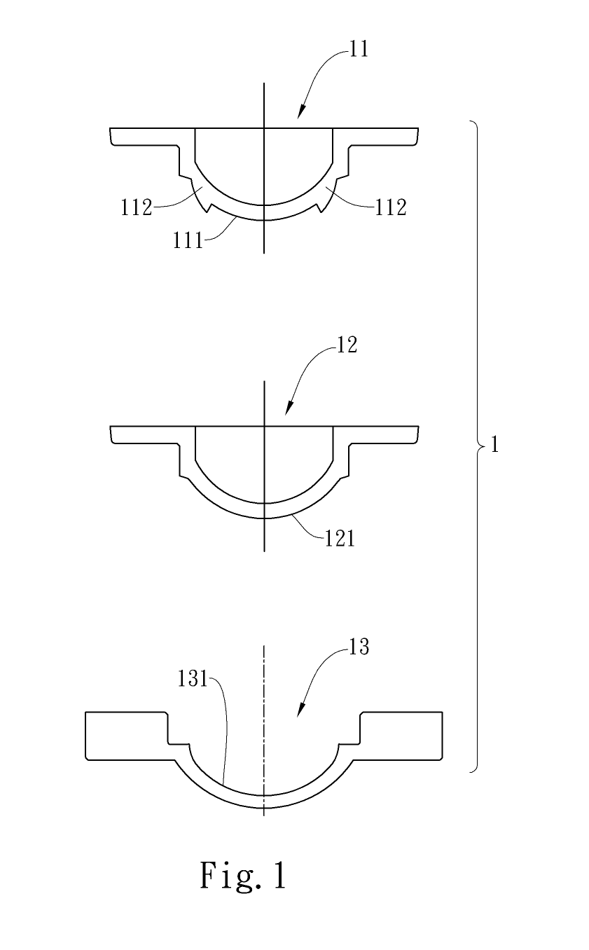

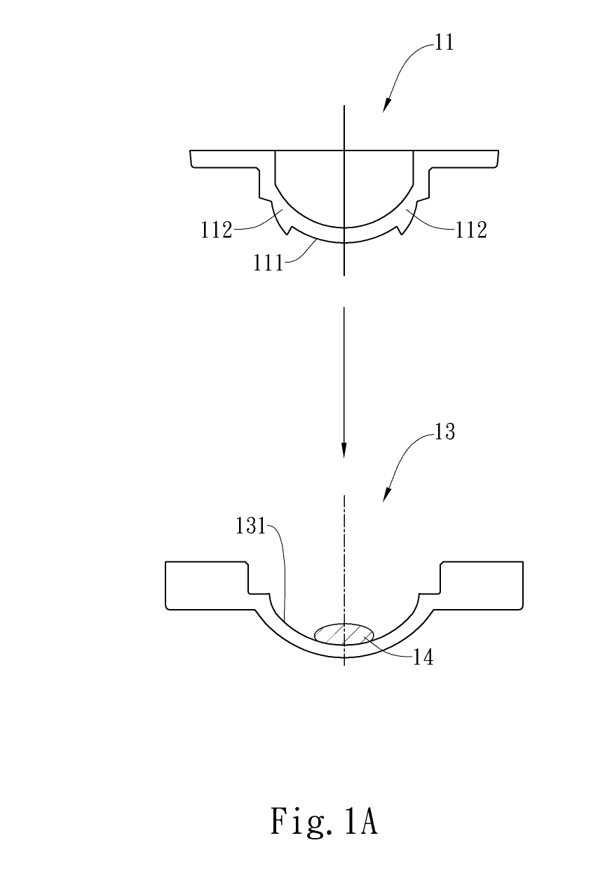

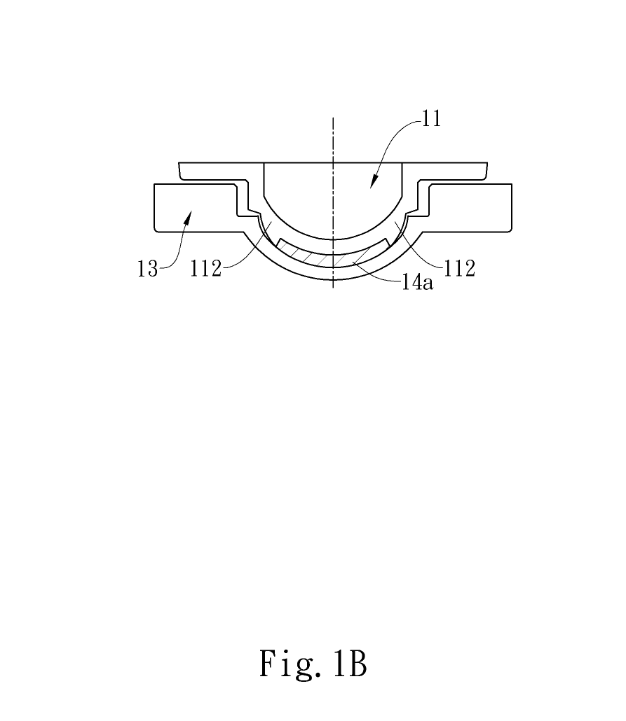

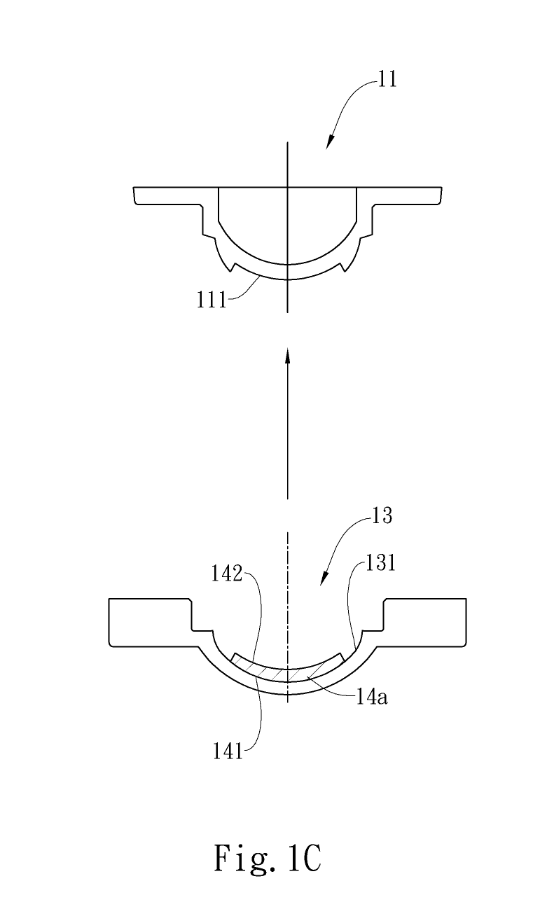

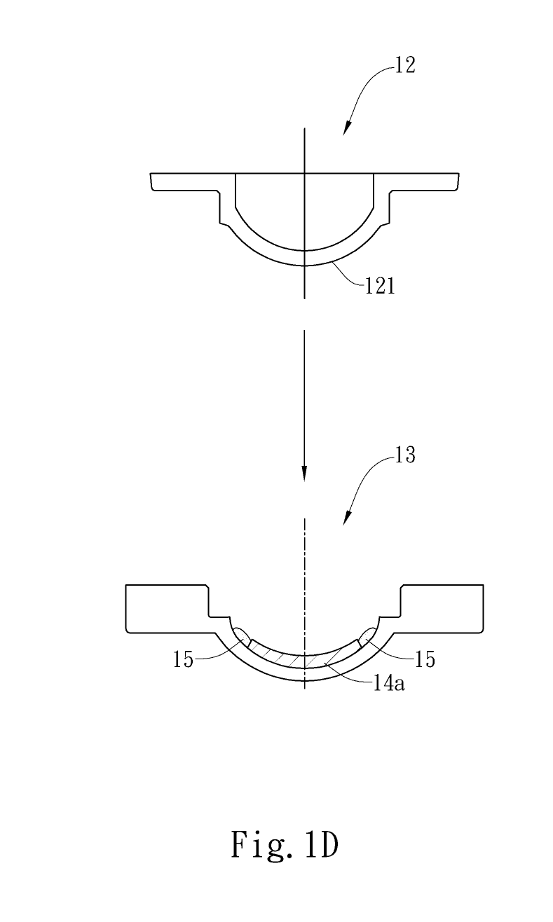

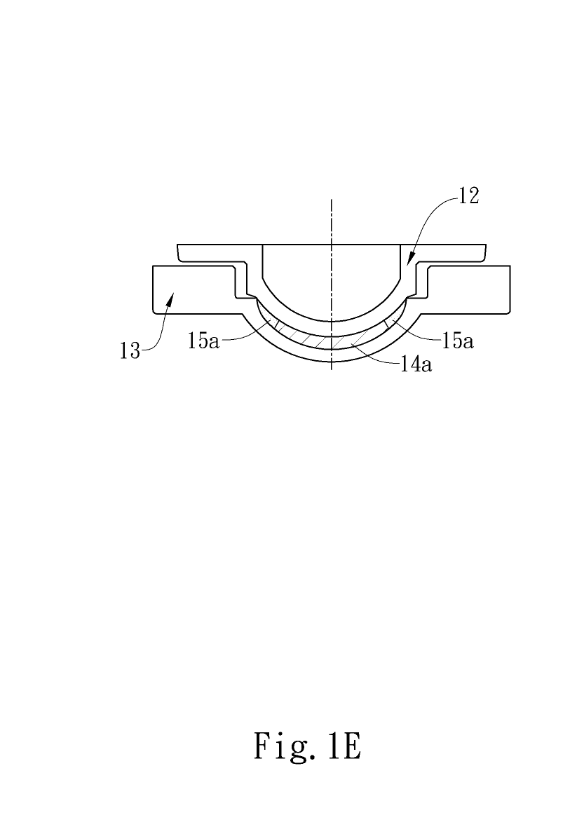

FIG. 1 shows a mold set 1 employed to manufacture a hybrid contact lens (comprising portions 14a and 15a) in accordance with a first embodiment of the present invention. The mold set 1 comprises a first upper mold 11, a second upper mold 12, and a lower mold 13. A lower surface of the first upper mold 11 comprises a convex first upper forming surface 111 which is disposed at a near-center region thereof and a flange 112 which is disposed at a near-periphery region thereof, wherein the flange 112 abuts the first upper forming surface 111 and protrudes downwardly. A lower surface of the second upper mold 12 comprises a convex second upper forming surface 121. An upper surface of the lower mold 13 comprises a concave lower forming surface 131.

FIGS. 1A to 1F are state diagrams of the molds in relative steps of manufacturing the hybrid contact lens (14a, 15a) using the mold set 1. First, position an unpolymerized first material 14 on a near-center region of the concave lower forming surface 131, as shown in FIG. 1A. Subsequently, assemble the first upper mold 11 and the lower mold 13, such that the flange 112 is positioned against a near-periphery region of the lower forming surface 131 to shape the first material 14 as a disk in an accommodation surrounded by a side wall of the flange 112, the first upper forming surface 111, and the near-center region of the lower forming surface 131. The first material 14 is then polymerized and modeled by means of baking, UV polymerization, or radiation polymerization to form a near-center region of the hybrid contact lens (14a, 15a) as a first portion 14a of the lens (14a, 15a), as shown in FIG. 1B. After that, as shown in FIG. 1C, separate the first upper mold 11 and the lower mold 13, and keep the first portion 14a on the near-center region of the lower forming surface 131 by using an ejector (not shown).

The first portion 14a may be a lens in dry or colloidal state. It is worth mentioning that a concave near-cornea surface 142 of the first portion 14a is formed through mold replication of the convex first upper forming surface 111, and a convex near-object surface 141 of the first portion 14a is formed through mold replication of the concave lower forming surface 131.

Following the above steps, then position an unpolymerized second material 15 on the near-periphery region of the lower forming surface 131 abutting the first portion 14a, as shown in FIG. 1D. Subsequently, assemble the second upper mold 12 and the lower mold 13, such that the first portion 14a kept on the lower forming surface 131 is positioned against a near-center region of the second upper forming surface 121 to shape the second material 15 as a ring in an accommodation surrounded by a near-periphery region of the second upper forming surface 121, the near-periphery region of the lower forming surface 131, and a side wall of the first portion 14a. The second material 15 is then polymerized and modeled by means of baking, UV polymerization, or radiation polymerization to form a near-periphery region of the hybrid contact lens (14a, 15a) as a second portion 15a of the lens (14a, 15a), wherein the second portion 15a and the first portion 14a are adhered to each other, as shown in FIG. 1E. After that, as shown in FIG. 1F, separate the second upper mold 12 and the lower mold 13, and keep the hybrid contact lens (14a, 15a) on the lower forming surface 131 by using an ejector (not shown).

The polymerized hybrid contact lens (14a, 15a) may be a lens in dry or colloidal state. It is worth mentioning that a concave near-cornea surface 152 of the second portion 15a is formed through mold replication of the convex second upper forming surface 121, and a convex near-object surface 151 of the second portion 15a is formed through mold replication of the concave lower forming surface 131.

Lastly, proceed with the hydration process of the hybrid contact lens (14a, 15a).

### The Second Embodiment

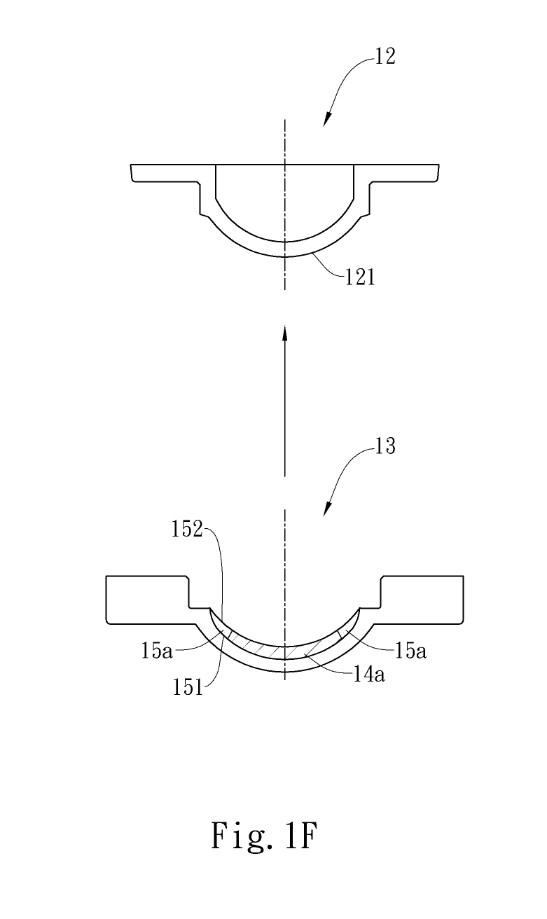

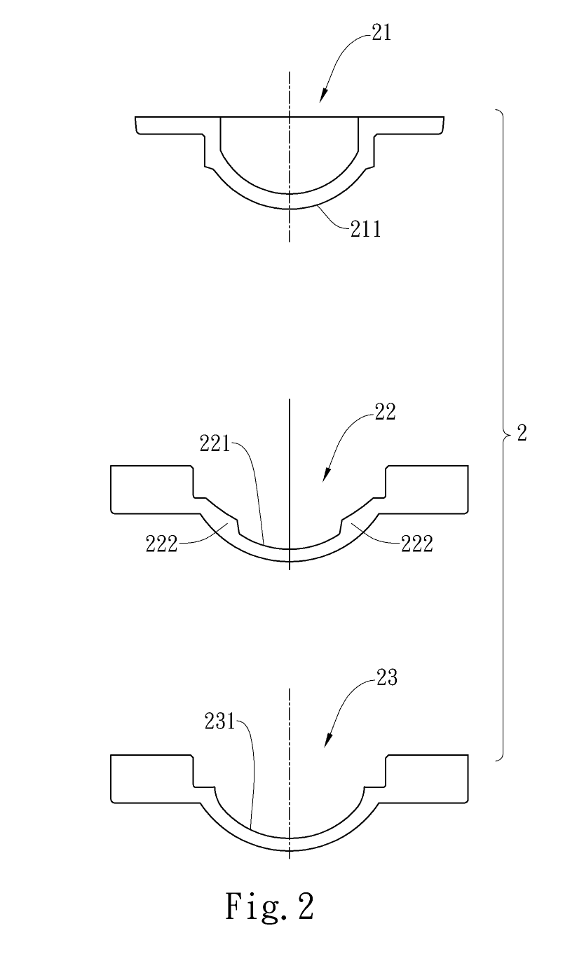

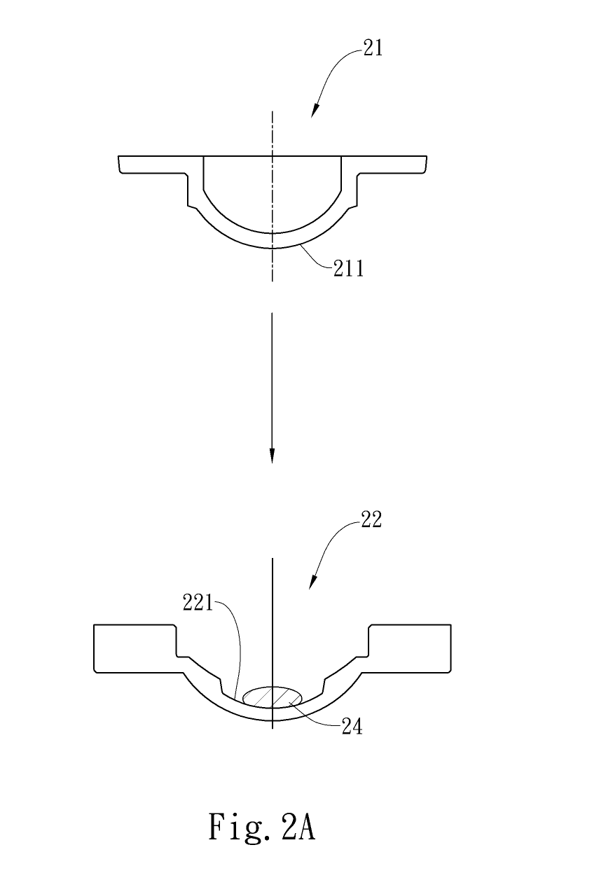

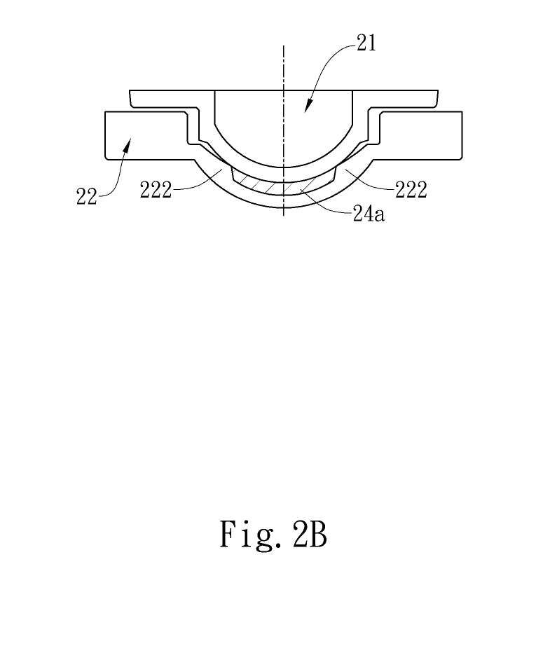

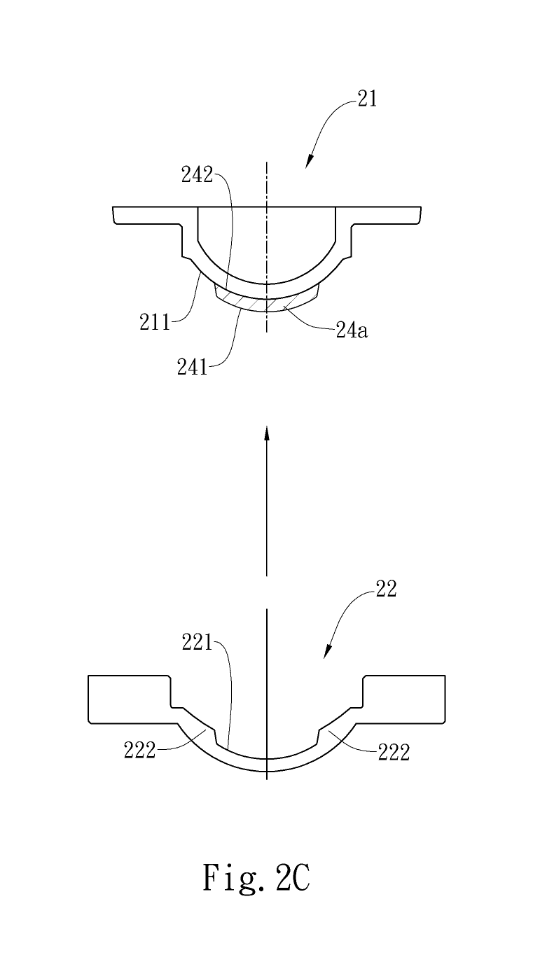

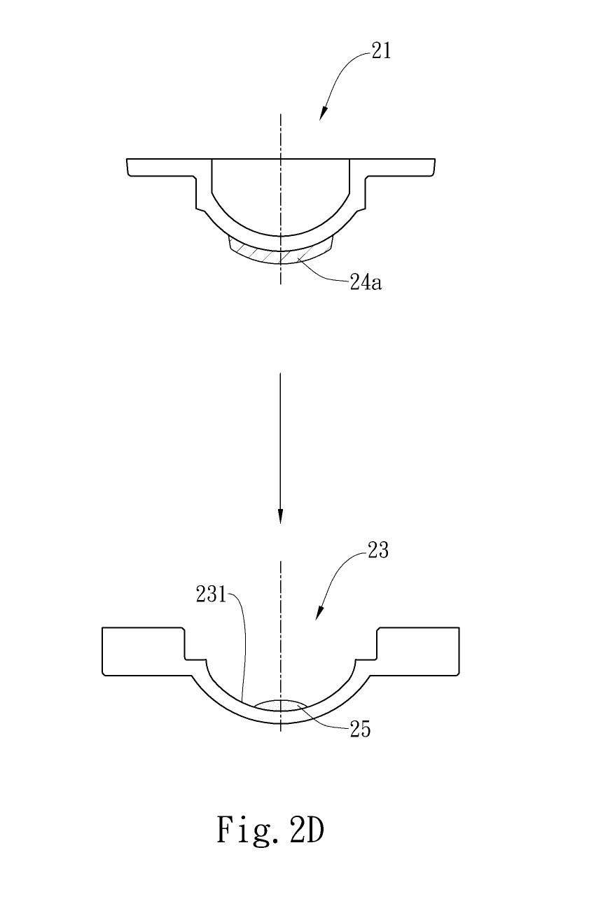

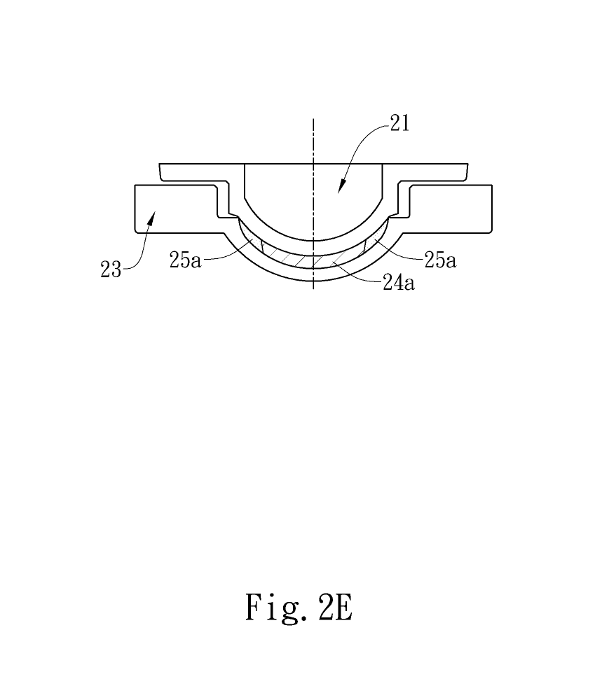

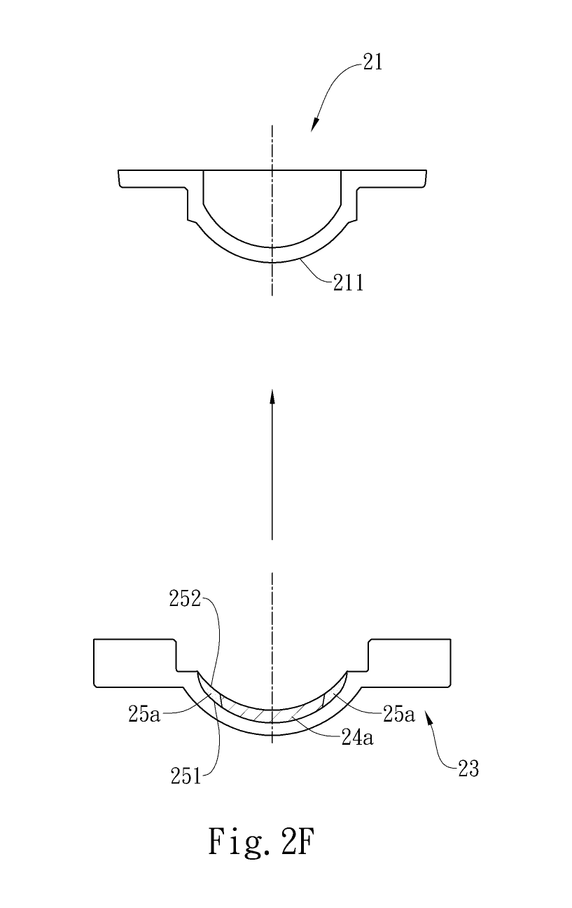

FIG. 2 shows a mold set 2 employed to manufacture a hybrid contact lens (comprising portions 24a and 25a) in accordance with a second embodiment of the present invention. The mold set 2 comprises an upper mold 21, a first lower mold 22, and a second lower mold 23. A lower surface of the upper mold 21 comprises a convex upper forming surface 211. An upper surface of the first lower mold 22 comprises a concave first lower forming surface 221 which is disposed at a near-center region thereof and a flange 222 disposed at a near-periphery region thereof, wherein the flange 222 abuts the first lower forming surface 221 and protrudes upwardly. An upper surface of the second lower mold 23 comprises a concave second lower forming surface 231.

FIGS. 2A to 2F are state diagrams of the molds in relative steps of manufacturing the hybrid contact lens (24a, 25a) using the mold set 2. First, position an unpolymerized first material 24 on a near-center region of the concave first lower forming surface 221, as shown in FIG. 2A. Subsequently, assemble the upper mold 21 and the first lower mold 22, such that the flange 222 is positioned against a near-periphery region of the upper forming surface 211 to shape the first material 24 as a disk in an accommodation surrounded by a side wall of the flange 222, a near-center region of the upper forming surface 211, and the first lower forming surface 221. The first material 24 is then polymerized and modeled by means of baking, UV polymerization, or radiation polymerization to form a near-center region of the hybrid contact lens (24a, 25a) as a first portion 24a of the lens (24a, 25a), as shown in FIG. 2B. After that, as shown in FIG. 2C, separate the upper mold 21 and the first lower mold 22, and keep the first portion 24a on the near-center region of the upper forming surface 211.

The first portion 24a may be a lens in dry or colloidal state. It is worth mentioning that a concave near-cornea surface 242 of the first portion 24a is formed through mold replication of the convex upper forming surface 211, and a convex near-object surface 241 of the first portion 24a is formed through mold replication of the concave first lower forming surface 221.

Following the above steps, then position an unpolymerized second material 25 on a near-center region of the second lower forming surface 231, as shown in FIG. 2D. Subsequently, assemble the upper mold 21 and the second lower mold 23, such that the first portion 24a kept on the upper forming surface 211 is positioned against the near-center region of the second lower forming surface 231 to squeeze the second material 25 out to a near-periphery region and shape the second material 25 as a ring in an accommodation surrounded by a side wall of the first portion 24a, the near-periphery region of the upper forming surface 211, and a near-periphery region of the second lower forming surface 231. The second material 25 is then polymerized and modeled by means of baking, UV polymerization, or radiation polymerization to form a near-periphery region of the hybrid contact lens (24a, 25a) as a second portion 25a of the lens (24a, 25a), wherein the second portion 25a and the first portion 24a are adhered to each other, as shown in FIG. 2E. After that, as shown in FIG. 2F, separate the upper mold 21 and the second lower mold 23 and keep the hybrid contact lens (24a, 25a) on the second lower forming surface 231 by using an ejector (not shown).

The polymerized hybrid contact lens (24a, 25a) may be a lens in dry or colloidal state. It is worth mentioning that a concave near-cornea surface 252 of the second portion 25a is formed through mold replication of the convex upper forming surface 211, and a convex near-object surface 251 of the second portion 25a is formed through mold replication of the concave second lower forming surface 231.

Lastly, proceed with the hydration process of the hybrid contact lens (24a, 25a).

### The Third Embodiment

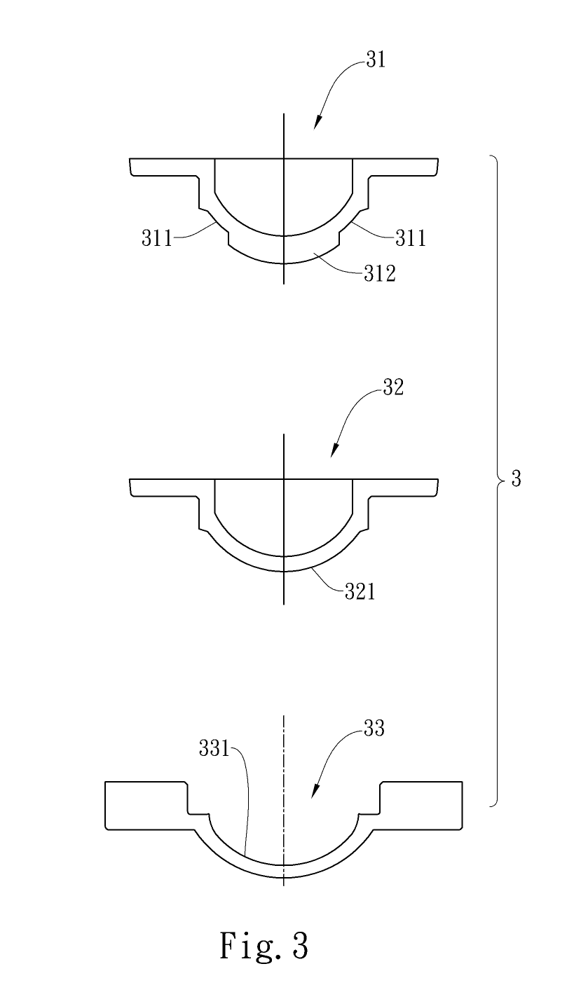

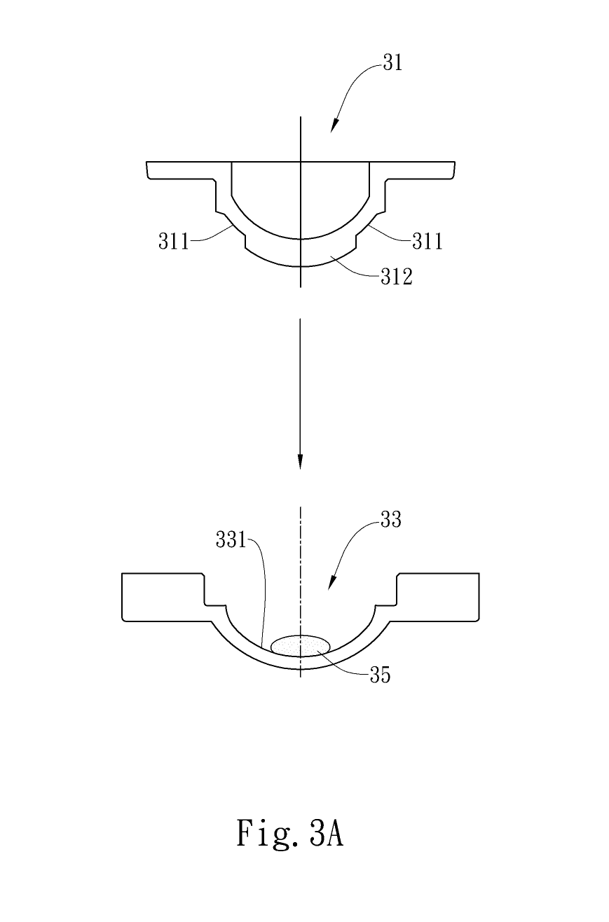

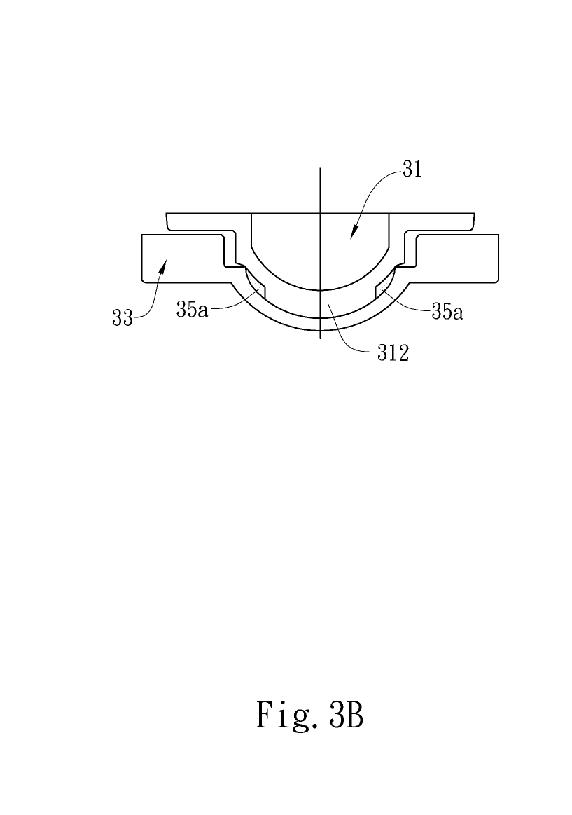

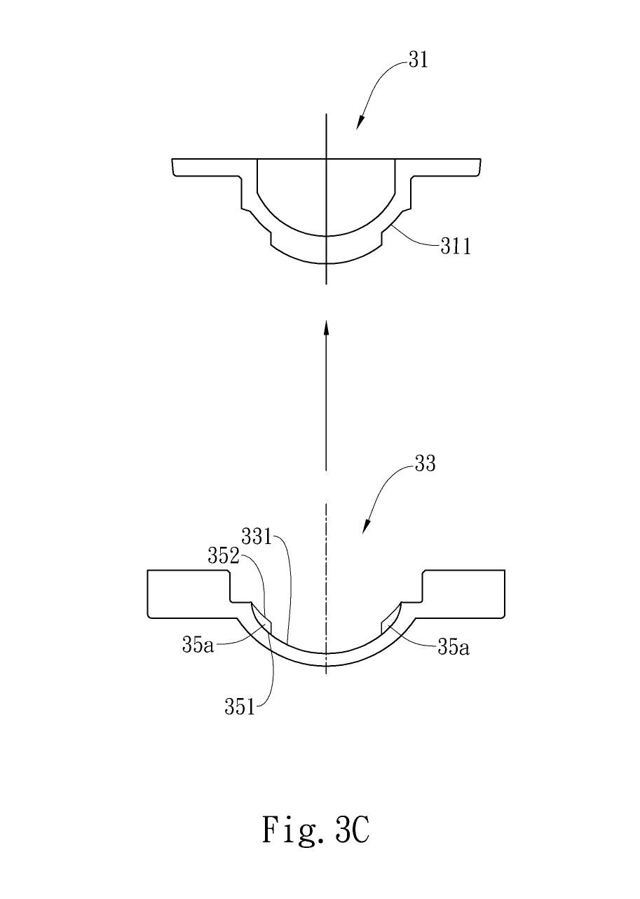

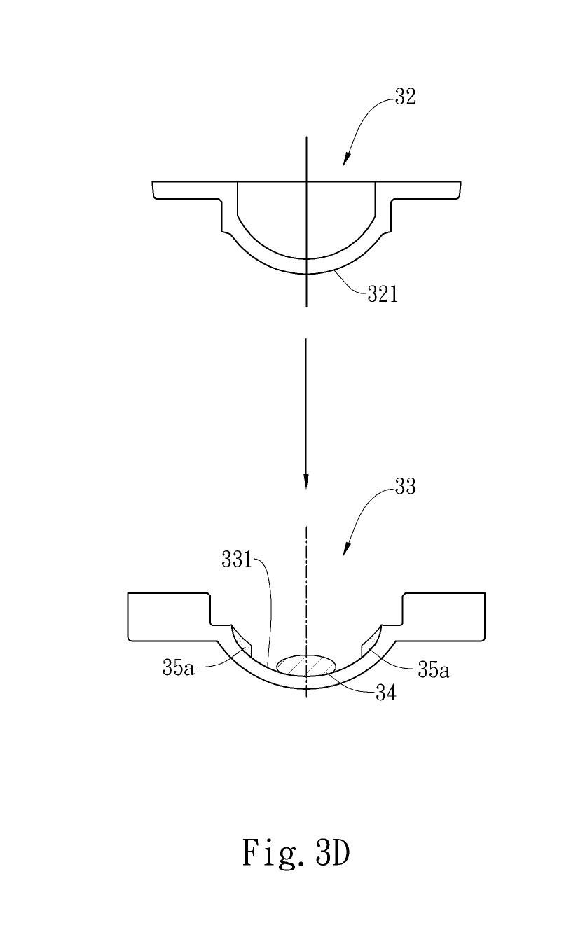

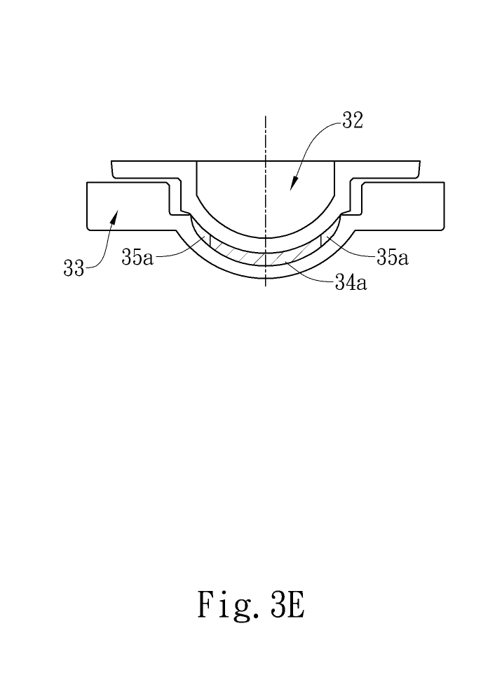

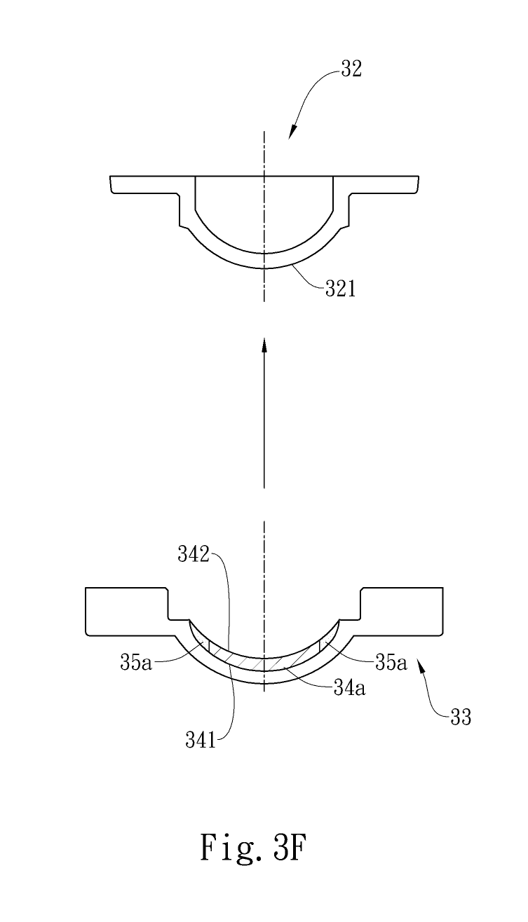

FIG. 3 shows a mold set 3 employed to manufacture a hybrid contact lens (comprising portions 34a and 35a) in accordance with a third embodiment of the present invention. The mold set 3 comprises a first upper mold 31, a second upper mold 32, and a lower mold 33. A lower surface of the first upper mold 31 comprises a convex first upper forming surface 311 which is disposed at a near-periphery region thereof and a flange 312 which is disposed at a near-center region thereof, wherein the flange 312 abuts the first upper forming surface 311 and protrudes downwardly. A lower surface of the second upper mold 32 comprises a convex second upper forming surface 321. An upper surface of the lower mold 33 comprises a concave lower forming surface 331.

FIGS. 3A to 3F are state diagrams of the molds in relative steps of manufacturing the hybrid contact lens (34a, 35a) using the mold set 3. First, position an unpolymerized second material 35 on a near-center region of the concave lower forming surface 331, as shown in FIG. 3A. Subsequently, assemble the first upper mold 31 and the lower mold 33, such that the flange 312 is positioned against a near-center region of the lower forming surface 331 to squeeze the second material 35 out to a near-periphery region and shape the second material 35 as a ring in an accommodation surrounded by a side wall of the flange 312, the first upper forming surface 311, and the near-periphery region of the lower forming surface 331. The second material 35 is then polymerized and modeled by means of baking, UV polymerization, or radiation polymerization to form a near-periphery region of the hybrid contact lens (34a, 35a) as a second portion 35a of the lens (34a, 35a), as shown in FIG. 3B. After that, as shown in FIG. 3C, separate the first upper mold 31 and the lower mold 33 and keep the second portion 35a on the near-periphery region of the lower forming surface 331 by using an ejector (not shown).

The second portion 35a may be a lens in dry or colloidal state. It is worth mentioning that a concave near-cornea surface 352 of the second portion 35a is formed through mold replication of the convex first upper forming surface 311, and a convex near-object surface 351 of the second portion 35a is formed through mold replication of the concave lower forming surface 331.

Following the above steps, then position an unpolymerized first material 34 on the near-center region of the lower forming surface 331, as shown in FIG. 3D. Subsequently, assemble the second upper mold 32 and the lower mold 33, such that the second portion 35a kept on the lower forming surface 331 is positioned against a near-periphery region of the second upper forming surface 321 to shape the first material 34 as a disk in an accommodation surrounded by a side wall of the second portion 35a, a near-center region of the second upper forming surface 321, and a near-center region of the lower forming surface 331. The first material 34 is then polymerized and modeled by means of baking, UV polymerization, or radiation polymerization to form a near-center region of the hybrid contact lens (34a, 35a) as a first portion 34a of the lens (34a, 35a), wherein the first portion 34a and the second portion 35a are adhered to each other, as shown in FIG. 3E. After that, as shown in FIG. 3F, separate the second upper mold 32 and the lower mold 33 and keep the hybrid contact lens (34a, 35a) on the lower forming surface 331 by using an ejector (not shown).

The polymerized hybrid contact lens (34a, 35a) may be a lens in dry or colloidal state. It is worth mentioning that a concave near-cornea surface 342 of the first portion 34a is formed through mold replication of the convex second upper forming surface 321, and a convex near-object surface 341 of the first portion 34a is formed through mold replication of the concave lower forming surface 331.

Lastly, proceed with the hydration process of the hybrid contact lens (34a, 35a).

### The Fourth Embodiment

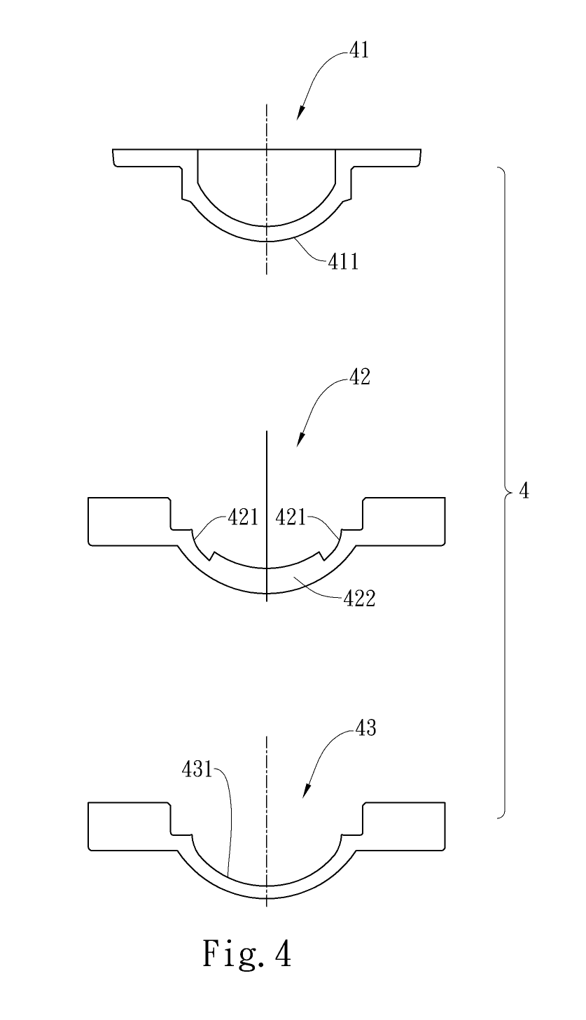

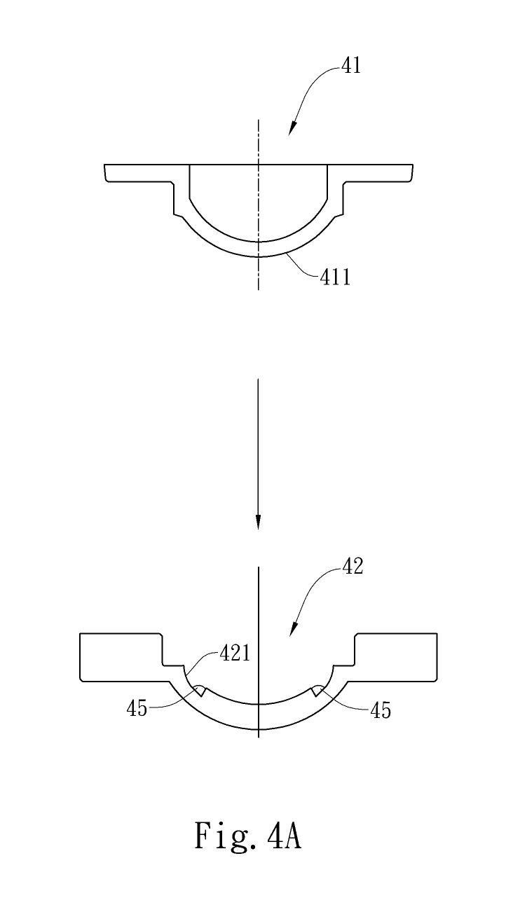

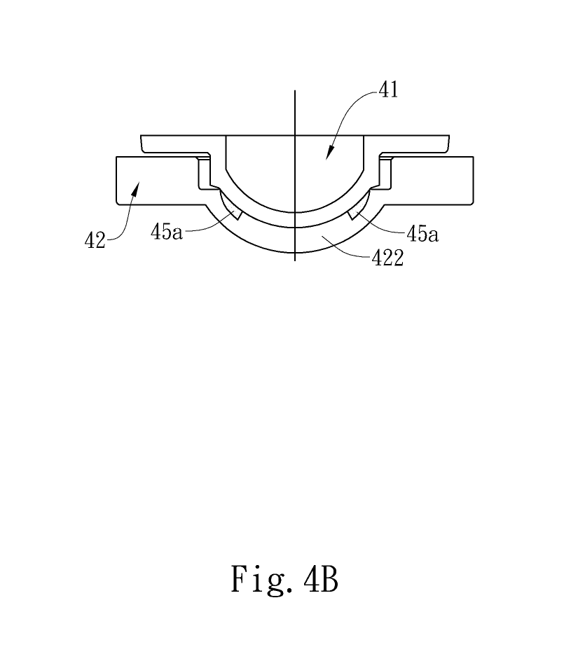

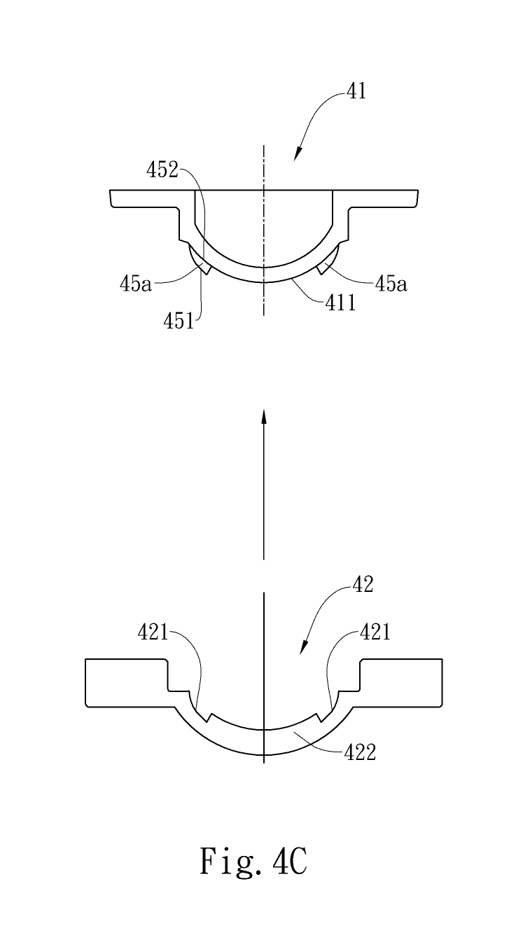

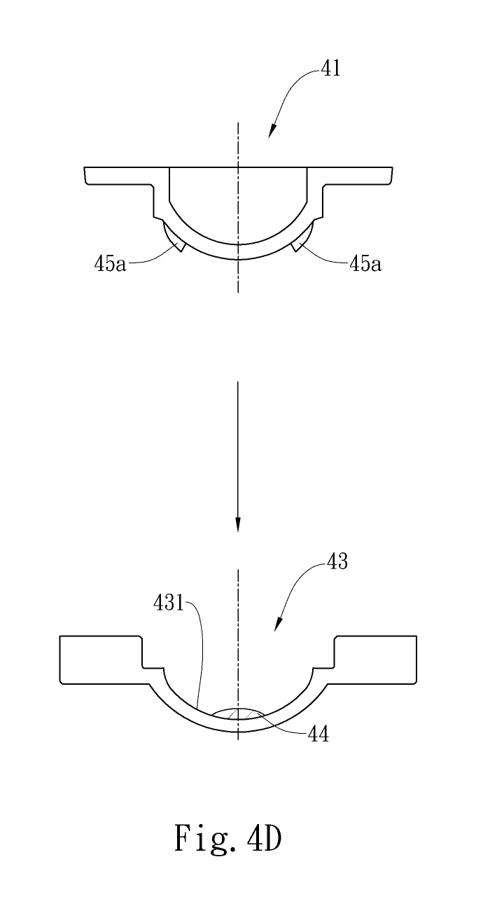

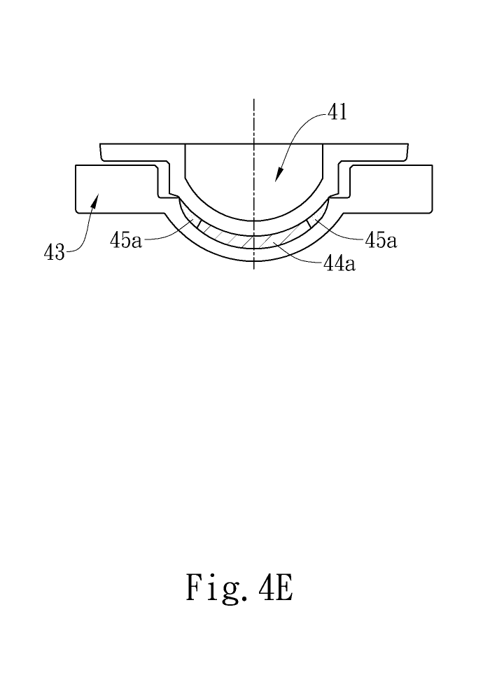

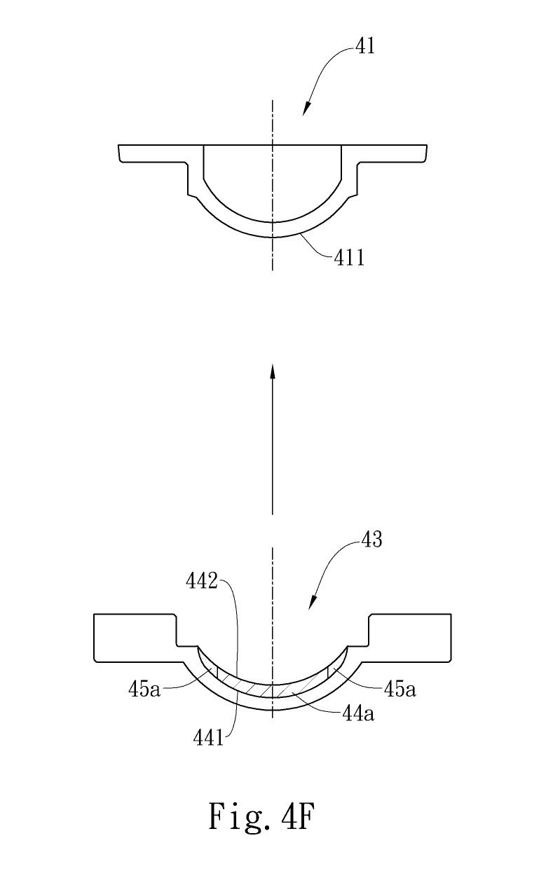

FIG. 4 shows a mold set 4 employed to manufacture a hybrid contact lens (comprising portions 44a and 45a) in accordance with a fourth embodiment of the present invention. The mold set 4 comprises an upper mold 41, a first lower mold 42, and a second lower mold 43. A lower surface of the upper mold 41 comprises a convex upper forming surface 411. An upper surface of the first lower mold 42 comprises a concave first lower forming surface 421 which disposed at a near-periphery region thereof and a flange 422 disposed at a near-center region thereof, wherein the flange 422 abuts the first lower forming surface 421 and protrudes upwardly. An upper surface of the second lower mold 43 comprises a concave second lower forming surface 431.

FIGS. 4A to 4F are state diagrams of the molds in relative steps of manufacturing the hybrid contact lens (44a, 45a) using the mold set 4. First, position an unpolymerized second material 45 on the concave first lower forming surface 421, as shown in FIG. 4A. Subsequently, assemble the upper mold 41 and the first lower mold 42, such that the flange 422 is positioned against a near-center region of the upper forming surface 411 to shape the second material 45 as a ring in an accommodation surrounded by a side wall of the flange 422, a near-periphery region of the upper forming surface 411, and the first lower forming surface 421. The second material 45 is then polymerized and modeled by means of baking, UV polymerization, or radiation polymerization to form a near-periphery region of the hybrid contact lens (44a, 45a) as a second portion 45a of the lens (44a, 45a), as shown in FIG. 4B. After that, as shown in FIG. 4C, separate the upper mold 41 and the first lower mold 42 and keep the second portion 45a on the near-periphery region of the upper forming surface 411.

The second portion 45a may be a lens in dry or colloidal state. It is worth mentioning that a concave near-cornea surface 452 of the second portion 45a is formed through mold replication of the convex upper forming surface 411, and a convex near-object surface 451 of the second portion 45a is formed through mold replication of the concave first lower forming surface 421.

Following the above steps, then position an unpolymerized first material 44 on a near-center region of the second lower forming surface 431, as shown in FIG. 4D. Subsequently, assemble the upper mold 41 and the second lower mold 43, such that the second portion 45a kept on the upper forming surface 411 is positioned against the near-periphery region of the second lower forming surface 431 to shape the first material 44 as a disk in an accommodation surrounded by a side wall of the second portion 45a, the near-center region of the upper forming surface 411, and a near-center region of the second lower forming surface 431. The first material 44 is then polymerized and modeled by means of baking, UV polymerization, or radiation polymerization to form a near-center region of the hybrid contact lens (44a, 45a) as a first portion 44a of the lens (44a, 45a), wherein the first portion 44a and the second portion 45a are adhered to each other, as shown in FIG. 4E. After that, as shown in FIG. 4F, separate the upper mold 41 and the second lower mold 43, and keep the hybrid contact lens (44a, 45a) on the second lower forming surface 431 by using an ejector (not shown).

The polymerized hybrid contact lens (44a, 45a) may be a lens in dry or colloidal state. It is worth mentioning that a concave near-cornea surface 442 of the first portion 44a is formed through mold replication of the convex upper forming surface 411, and a convex near-object surface 441 of the first portion 44a is formed through mold replication of the concave second lower forming surface 431.

Lastly, proceed with the hydration process of the hybrid contact lens (44a, 45a).

Preferably, those mold sets (1, 2, 3, and 4) in the aforementioned embodiments may be made of plastic or glass, which is transparent for light, such that UV light used for polymerization is allowed to penetrate those molds to perform the polymerization process.

Moreover, in the aforementioned embodiments, the first material (14, 24, 34, and 44) may be a material having high oxygen permeability which is used for manufacturing either a rigid contact lens or a soft contact lens, in particular a hydratable high polymer material having high oxygen permeability, such as a material containing silicone. The second material (15, 25, 35, and 45) may be a material having a high water content, or a material used for manufacturing a soft contact lens which has both high oxygen permeability and a high water content, in particular a hydratable high polymer material having a high water content, such as a material containing HEMA (2-hydroxyethyl methacrylate).

With the different properties of the materials mentioned above, the first portion (14a, 24a, 34a, and 44a) which is disposed at the near-center region of the hybrid contact lens (14a and 15a, 24a and 25a, 34a and 35a, 44a and 45a) has high oxygen permeability and provides the cornea with sufficient oxygen through the human tear film, while the second portion (15a, 25a, 35a, and 45a) which is disposed at the near-periphery region of the hybrid contact lens (14a and 15a, 24a and 25a, 34a and 35a, 44a and 45a) has a high water content and increases wearing comfort.

The aforementioned embodiments are provided only for the purpose of explanation, rather than a limitation on the scope of the present invention with examples of the manufacturing methods and mold sets employed in the present invention. For those skilled in the art, it is easy to derive different manufacturing methods and its relative mold sets from the disclosure of the present invention to model different shapes of first portions and second portions, in addition to a disk-like shape and a ring-like shape as previously described. Hybrid contact lenses manufactured by the hybrid cast molding method of the present invention are instanced and described below.

### The First Example

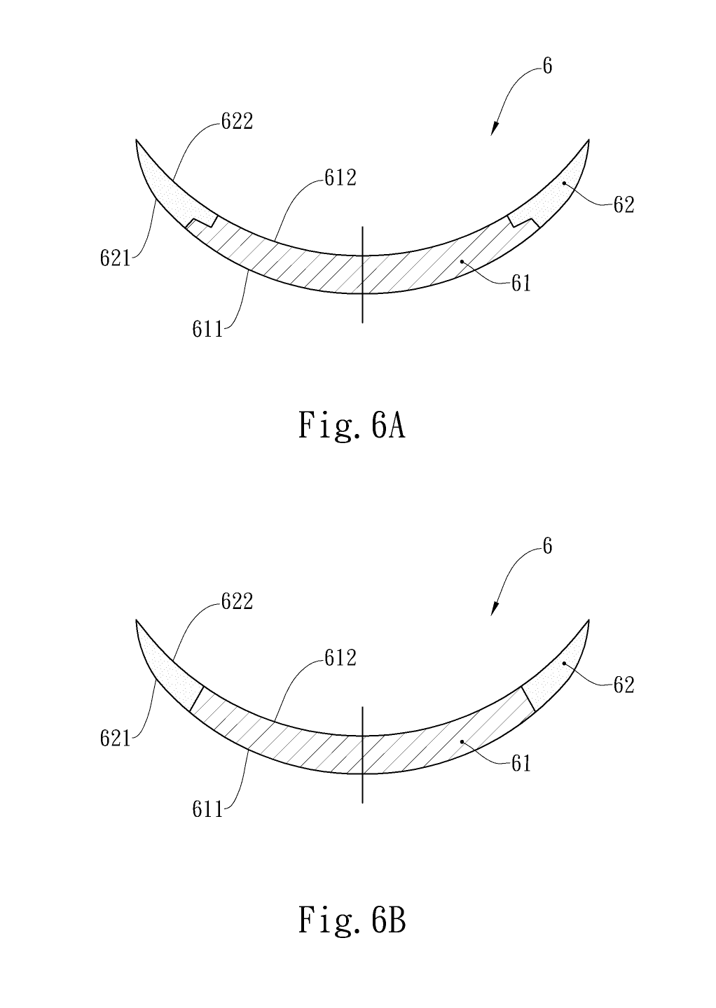

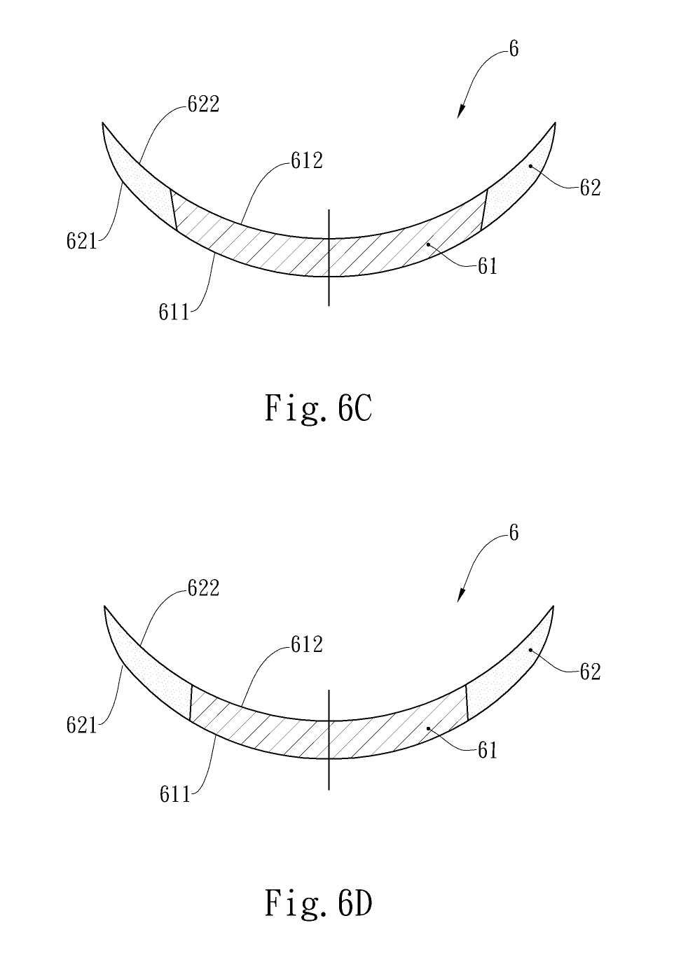

FIG. 6A shows a sectional view of a hybrid contact lens in accordance with the first example of the present invention. A hybrid contact lens 6 is composed of a first portion 61 and a second portion 62, which are concentrically disposed relative to a center of the hybrid contact lens 6 and adhered to each other. The first portion 61 forms a near-center region of the lens 6 in a disk-like shape and has vision correction properties; the second portion 62 forms a near-periphery region of the lens 6 in a ring-like shape.

More details are described below. A near-object surface 611 of the first portion 61 and a near-object surface 621 of the second portion 62 are adhered to each other to form a near-object surface of the hybrid contact lens 6; a near-cornea surface 612 of the first portion 61 and a near-cornea surface 622 of the second portion 62 are adhered to each other to form a near-cornea surface of the hybrid contact lens 6. It is worth mentioning that, as shown in FIGS. 6A to 6D, the lateral interface between the adhered edges of the first portion 61 and the second portion 62 may be in one of the following patterns: a step pattern (as shown in FIG. 6A); a straight plane pattern, wherein the lateral interface intersecting a tangent plane of the near-object surface of the hybrid contact lens 6 and a tangent plane of the near-cornea surface of the hybrid contact lens 6 both at right angles (as shown in FIG. 6B); and another straight plane pattern, wherein the lateral interface intersecting the tangent plane of the of the near-object surface of the hybrid contact lens 6 and the tangent plane of the near-cornea surface of the hybrid contact lens 6 at other angles (as shown in FIG. 6C and FIG. 6D). Different patterns of the lateral interface have different adhesion properties and result in different lens tenacities.

In the aforementioned hybrid contact lens 6, the first portion 61 disposed at the near-center region has a diopter power for vision correction and provides the cornea with sufficient oxygen accessibility, while the second portion 62 disposed at the near-periphery region alleviates wearing discomfort.

### The Second Example

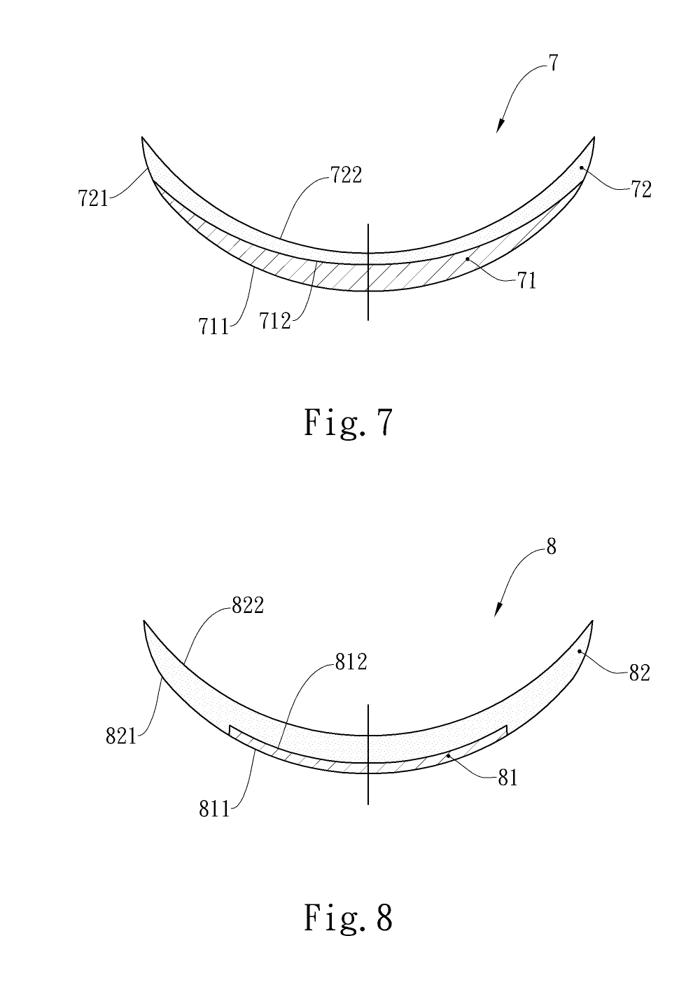

FIG. 7 shows a sectional view of a hybrid contact lens in accordance with the second example of the present invention. A hybrid contact lens 7 is composed of a first portion 71 and a second portion 72, which are disposed concentrically relative to a center of the hybrid contact lens 7 and adhered to each other. The first portion 71 is shaped as a disk and has vision correction properties; the second portion 72 is shaped as a ring.

More details are described below. A near-object surface 711 of the first portion 71 and a near-periphery region of a near-object surface 721 of the second portion 72 are adhered to each other to form a near-object surface of the hybrid contact lens 7; a near-cornea surface 722 of the second portion 72 forms a near-cornea surface of the hybrid contact lens 7; and a near-cornea surface 712 of the first portion 71 adheres to a near-center region of the near-object surface 721 of the second portion 72.

In the aforementioned hybrid contact lens 7, the first portion 71 has a diopter power for vision correction and increases oxygen permeability of the lens, while the second portion 72 fits the eyeball and alleviates wearing discomfort.

### The Third Example

FIG. 8 shows a sectional view of a hybrid contact lens in accordance with the third example of the present invention. A hybrid contact lens 8 is composed of a first portion 81 and a second portion 82, which are concentrically disposed relative to a center of the hybrid contact lens 8 and adhered to each other. The first portion 81 is shaped as a disk to form a portion of a near-center region of the lens 8; the second portion 82 is also shaped as a disk, wherein a near-center region of a near-object surface 821 thereof is indented and forms a near-periphery region and a portion of a near-center region of the lens 8.

More details are described below. A near-object surface 811 of the first portion 81 and a near-object surface 821 of the second portion 82 are adhered to each other to form a near-object surface of the hybrid contact lens 8; a near-cornea surface 822 of the second portion 82 forms a near-cornea surface of the hybrid contact lens 8; and the indented portion of the near-object surface 821 at the near-center region of the second portion 82 is adhered to side walls and the near-cornea surface 812 of the first portion 81 to form the complete disk-like lens 8.

In the aforementioned hybrid contact lens 8, the first portion 81 has a diopter power for vision correction and increases oxygen permeability of the lens, while the second portion 82 disposed at the near-center region fits the eyeball and alleviates wearing discomfort.

### The Fourth Example

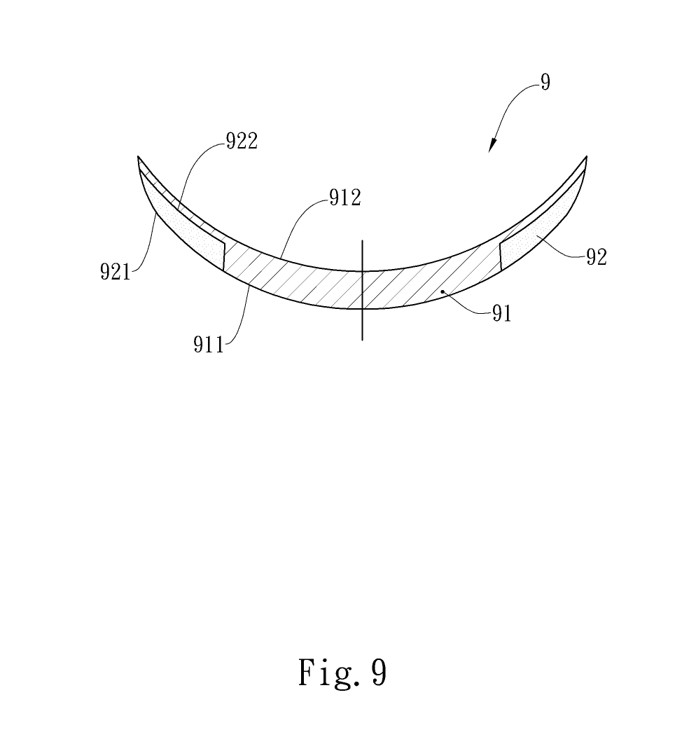

FIG. 9 shows a sectional view of a hybrid contact lens in accordance with the fourth example of the present invention. A hybrid contact lens 9 is composed of a first portion 91 and second portion 92, which are disposed concentrically relative to a center of the hybrid contact lens and adhered to each other. The first portion 91 is shaped as a disk, wherein a near-periphery region of a near-object surface 911 thereof has an indented portion; the first portion 91 forms a near-center region and a portion of a near-periphery region of the lens 9. The second portion 92 is shaped as a ring and forms a portion of the near-periphery region of the lens 9.

More details are described below. The near-objective surface 911 of the first portion 91 and a near-object surface 921 of the second portion 92 are adhered to form a near-object surface of the hybrid contact lens 9; a near-cornea surface 912 of the first portion 91 forms a near-cornea surface of the hybrid contact lens 9; and a side wall and the near-cornea surface 922 of the second portion 92 are adhered to the indented portion which is positioned at the near-periphery region of the near-object surface 911 of the first portion 91 to form a complete disk-like lens 9.

In the aforementioned hybrid contact lens 9, the first portion 91 extending from the near-center region to the near-periphery region has a diopter power for vision correction and increases oxygen permeability of the lens, while the second portion 92 disposed at the near-periphery region alleviates wearing discomfort.

In the aforementioned examples, hydratable high polymer materials which can be utilized to form the first portion (61, 71, 81, 91) and the second portion (62, 72, 82, 92) may be different (for example, a first material and a second material are used as mentioned above). Preferably, a material containing silicone is utilized to form the first portion, while a material containing HEMA is utilized to form the second portion. Thus, the first portion (61, 71, 81, 91) of the hybrid contact lens (6, 7, 8, 9) of the present invention has high oxygen permeability so as to provide the cornea with sufficient oxygen through the human tear film; the second portion (62, 72, 82, 92) has a high water content so as to increase wearing comfort with its softer quality. According to the aforementioned embodiments and examples, it is clear that the first portion and the second portion of the hybrid contact lens of the present invention can have various shapes and adhesion patterns. Compared with conventional technologies for manufacturing a hybrid contact lens, such as spin casting or turning process, the manufacturing method according to the present invention enables production simplification of hybrid contact lenses for mass production; moreover, the hybrid contact lens thus produced can have a specific diopter power for vision correction depending on client needs. The present invention is not limited by the aforementioned embodiments and examples. Various changes and modifications having the same effect and made without departing from the spirit of the present invention should fall within the scope of the appended claims.

What is claimed is:

1. A mold set for manufacturing a hybrid contact lens, comprising:
a first upper mold, wherein a lower surface of the first upper mold comprises:
a convex first upper forming surface, and
a protruding flange which is disposed at a near-periphery region of the lower surface;
a second upper mold, wherein a lower surface of the second upper mold comprises a convex second upper forming surface; and
a lower mold, wherein an upper surface of the lower mold comprises a concave lower forming surface.

2. The mold set according to claim 1, wherein the mold set is made of plastic or glass.

3. A hybrid cast molding method employing the mold set of claim 2 for manufacturing a hybrid contact lens, comprising the following steps:
positioning an unpolymerized first material on the lower forming surface of the lower mold;
assembling the first upper forming surface of the first upper mold and the lower forming surface of the lower mold;
polymerizing and modeling the first material to form a near-center region of a hybrid contact lens as a first portion of the lens;
positioning an unpolymerized second material on the lower forming surface of the lower mold;
assembling the second upper forming surface of the second upper mold and the lower forming surface of the lower mold;
polymerizing and modeling the second material to form a near-periphery region of the hybrid contact lens as a second portion of the lens, wherein the second portion and the first portion are adhered to each other; and
hydrating the hybrid contact lens.

4. A hybrid contact lens manufactured by using the mold set of claim 1, comprising:
a first portion and a second portion adhered to each other and being concentrically disposed relative to a center of the hybrid contact lens, the first portion and the second portion forming a near-center region and a near-periphery region of the hybrid contact lens respectively; wherein,
the first portion has vision correction properties;
the first portion and the second portion are made from different hydratable polymer materials; and
the second portion is made from a material containing HEMA (2-hydroxyethyl methacrylate).

5. The hybrid contact lens according to claim 4, wherein the first portion is made from a material containing silicon.

6. The hybrid contact lens according to claim 4, wherein the first portion has a disk-like shape, and the second portion has a ring-like shape.

7. The hybrid contact lens according to claim 4, wherein the first portion has a disk-like shape, and the second portion has a disk-like shape.

8. A mold set for manufacturing a hybrid contact lens, comprising:
an upper mold, wherein a lower surface of the upper mold comprises a convex upper forming surface;
a first lower mold, wherein an upper surface of the first lower mold comprises:
a concave first lower forming surface, and
a protruding flange which is disposed at a near-periphery region of the upper surface; and
a second lower mold, wherein an upper surface of the second lower mold comprises a concave second lower forming surface.

9. The mold set according to claim 8, wherein the mold set is made of plastic or glass.

10. A hybrid cast molding method employing the mold set of claim 9 for manufacturing a hybrid contact lens, comprising the following steps:
positioning an unpolymerized first material on the first lower forming surface of the first lower mold;
assembling the upper forming surface of the upper mold and the first lower forming surface of the first lower mold;
polymerizing and modeling the first material to form a near-center region of a hybrid contact lens as a first portion of the lens;
positioning an unpolymerized second material on the second lower forming surface of the second lower mold;
assembling the upper forming surface of the upper mold and the second lower forming surface of the second lower mold;
polymerizing and modeling the second material to form a near-periphery region of the hybrid contact lens as a second portion of the lens, wherein the second portion and the first portion are adhered to each other; and
hydrating the hybrid contact lens.

11. A hybrid contact lens manufactured by using the mold set of claim 8, comprising:
a first portion and a second portion adhered to each other and being concentrically disposed relative to a center of the hybrid contact lens, the first portion and the second portion forming a near-center region and a near-periphery region of the hybrid contact lens respectively; wherein,
the first portion has vision correction properties;
the first portion and the second portion are made from different hydratable polymer materials; and
the second portion is made from a material containing HEMA (2-hydroxyethyl methacrylate).

12. The hybrid contact lens according to claim 11, wherein the first portion is made from a material containing silicon.

13. The hybrid contact lens according to claim 11, wherein the first portion has a disk-like shape, and the second portion has a ring-like shape.

14. The hybrid contact lens according to claim 11, wherein the first portion has a disk-like shape, and the second portion has a disk-like shape.

15. A mold set for manufacturing a hybrid contact lens, comprising:
a first upper mold, wherein a lower surface of the first upper mold comprises:
a convex first upper forming surface, and
a protruding flange which is disposed at a near-center region of the lower surface;
a second upper mold, wherein a lower surface of the second upper mold comprises a convex second upper forming surface; and
a lower mold, wherein an upper surface of the lower mold comprises a concave lower forming surface.

16. The mold set according to claim 15, wherein the mold set is made of plastic or glass.

17. A hybrid cast molding method employing the mold set of claim 16 for manufacturing a hybrid contact lens, comprising the following steps:
positioning an unpolymerized second material on the lower forming surface of the lower mold;
assembling the first upper forming surface of the first upper mold and the lower forming surface of the lower mold;
polymerizing and modeling the second material to form a near-periphery region of a hybrid contact lens as a second portion of the lens;
positioning an unpolymerized first material on the lower forming surface of the lower mold;
assembling the second upper forming surface of the second upper mold and the lower forming surface of the lower mold;
polymerizing and modeling the first material to form a near-center region of the hybrid contact lens as a first portion of the lens, wherein the first portion and the second portion are adhered to each other; and
hydrating the hybrid contact lens.

18. A hybrid contact lens manufactured by using the mold set of claim 15, comprising:
a first portion and a second portion adhered to each other and being concentrically disposed relative to a center of the hybrid contact lens, the first portion and the second portion forming a near-center region and a near-periphery region of the hybrid contact lens respectively; wherein,
the first portion has vision correction properties;
the first portion and the second portion are made from different hydratable polymer materials; and
the second portion is made from a material containing HEMA (2-hydroxyethyl methacrylate).

19. The hybrid contact lens according to claim 18, wherein the first portion is made from a material containing silicon.

20. The hybrid contact lens according to claim 18, wherein the first portion has a disk-like shape, and the second portion has a ring-like shape.

21. The hybrid contact lens according to claim 18, wherein the first portion has a disk-like shape, and the second portion has a disk-like shape.

22. A mold set for manufacturing a hybrid contact lens, comprising:
an upper mold, wherein a lower surface of the upper mold comprises a convex upper forming surface;
a first lower mold, wherein an upper surface of the first lower mold comprises:
a concave first lower forming surface, and
a protruding flange which is disposed at a near-center region of the upper surface; and
a second lower mold, wherein an upper surface of the second lower mold comprises a concave second lower forming surface.

23. The mold set according to claim 22, wherein the mold set is made of plastic or glass.

24. A hybrid cast molding method employing the mold set of claim 23 for manufacturing a hybrid contact lens, comprising the following steps:
positioning an unpolymerized second material on the first lower forming surface of the first lower mold;
assembling the upper forming surface of the upper mold and the first lower forming surface of the first lower mold;
polymerizing and modeling the second material as to form a near-periphery region of the a hybrid contact lens to form as a second portion of the lens;
positioning an unpolymerized first material on the second lower forming surface of the second lower mold;
assembling the upper forming surface of the upper mold and the second lower forming surface of the second lower mold;
polymerizing and modeling the first material as to form a near-center region of the hybrid contact lens to as a first portion of the lens, wherein the first portion and the second portion are adhered to each other; and
hydrating the hybrid contact lens.

25. A hybrid contact lens manufactured by using the mold set of claim 22, comprising:
a first portion and a second portion adhered to each other and being concentrically disposed relative to a center of the hybrid contact lens, the first portion and the second portion forming a near-center region and a near-periphery region of the hybrid contact lens respectively; wherein,
the first portion has vision correction properties;
the first portion and the second portion are made from different hydratable polymer materials; and
the second portion is made from a material containing HEMA (2-hydroxyethyl methacrylate).

26. The hybrid contact lens according to claim 25, wherein the first portion is made from a material containing silicon.

27. The hybrid contact lens according to claim 25, wherein the first portion has a disk-like shape, and the second portion has a ring-like shape.

28. The hybrid contact lens according to claim 25, wherein the first portion has a disk-like shape, and the second portion has a disk-like shape.
